(19) United States
(12) Patent Application Publication
(10) Pub. No.: US 2024/0424799 A1
(43) Pub. Date: Dec. 26, 2024

(54) LIQUID REPLENISHMENT CONTAINER

(71) Applicant: SEIKO EPSON CORPORATION, Tokyo (JP)

(72) Inventors: Yuta KOIKE, Matsumoto-shi (JP); Tadahiro MIZUTANI, Shiojiri-shi (JP)

(73) Assignee: SEIKO EPSON CORPORATION, Tokyo (JP)

(21) Appl. No.: 18/747,089

(22) Filed: Jun. 18, 2024

(30) Foreign Application Priority Data
Jun. 20, 2023 (JP) 2023-100492

(51) Int. Cl. B41J 2/175

(52) U.S. Cl. CPC B41J 2/17509; B41J 2/17596

(57) ABSTRACT

A liquid outlet-forming portion included in a liquid replenishment container includes a sealing member disposed in a liquid outflow path, a valve disposed in the liquid outflow path, and a flow path closing member disposed in the liquid outflow path between an opening and the valve. The valve is a spring valve including a spring member, a valve body that is urged by the spring member toward the sealing member in a valve-closed state, and a contact portion that is coupled to the valve body and comes into contact with the flow path closing member at least in a valve-open state. The flow path closing member is an inner plug engaged with the liquid outlet-forming portion. The inner plug is disengaged from the liquid outlet-forming portion by a liquid introduction needle via the valve when the liquid replenishment container is used for the first time.

The present application is based on, and claims priority from JP Application Serial Number 2023-100492, filed Jun. 20, 2023, the disclosure of which is hereby incorporated by reference herein in its entirety.

### BACKGROUND

### 1. Technical Field

The present disclosure relates to a liquid replenishment container.

### 2. Related Art

Hitherto, an ink jet printer that can perform printing on a print medium such as printing paper with ink by ejecting the ink from a print head toward the print medium has been known as an example of an ink ejecting apparatus. Examples of such an ink jet printer include an ink replenishment type printer that is used by replenishing ink in an ink tank.

JP-A-2022-18712 discloses a liquid replenishment container for replenishing ink in such a type of ink jet printer. The liquid replenishment container described in JP-A-2022-18712 includes a bottle, a nozzle, and a cap. Furthermore, the liquid replenishment container has two sealing portions as a structure to prevent ink leakage. In a first sealing portion, sealing is performed by fitting the cap and the nozzle. In a second sealing portion, sealing is performed by a valve structure within the nozzle. In a process of removing the cap from the nozzle, the first sealing portion and the second sealing portion are simultaneously opened, thereby allowing the container to communicate with the atmosphere and relieving a pressurized state within the container.

However, in the liquid replenishment container described above, in the process of removing the cap, the inside of the bottle transitions from a pressurized state to near atmospheric pressure, which somewhat suppresses ink spouting. However, it is difficult to completely prevent ink spouting. Therefore, there is a possibility that the spouted ink may adhere to an outer side of the nozzle or leak out of the cap. In addition, there is a possibility that contamination with ink occurs before the bottle is mounted on the printer when the bottle is used for the first time.

### SUMMARY

The present disclosure can be implemented in the following aspects.

According to a first aspect of the present disclosure, a liquid replenishment container is provided. The liquid replenishment container is a liquid replenishment container that replenishes a liquid in a liquid ejecting apparatus including a liquid introduction needle via the liquid introduction needle, the liquid replenishment container including: a container body portion having an opening and configured to contain the liquid; and a liquid outlet-forming portion coupled to the container body portion and including a cylindrical portion that defines a liquid outflow path communicating with the opening, in which the liquid outlet-forming portion includes a sealing member disposed in the liquid outflow path, a valve disposed in the liquid outflow path, and a flow path closing member disposed in the liquid outflow path between the opening and the valve, the valve includes a spring member, a valve body that comes into contact with the sealing member by being urged by the spring member in a valve-closed state and is separated from the sealing member by being pressed by the liquid introduction needle inserted into the liquid outflow path in a valve-open state, and a contact portion that moves in conjunction with the valve body at least in the valve-open state and comes into contact with the flow path closing member, and the flow path closing member is an inner plug that is engaged with the liquid outlet-forming portion, the inner plug configured to be disengaged from the liquid outlet-forming portion by being pressed by the liquid introduction needle via the valve when the liquid replenishment container is used for the first time.

According to a second aspect of the present disclosure, a liquid replenishment container is provided. The liquid replenishment container is a liquid replenishment container that replenishes a liquid in a liquid ejecting apparatus including a liquid introduction needle via the liquid introduction needle, the liquid replenishment container including: a container body portion having an opening and configured to contain the liquid; and a liquid outlet-forming portion including a cylindrical portion that defines a liquid outflow path communicating with the opening, in which the liquid outlet-forming portion includes a valve that is disposed in the liquid outflow path, is opened when the liquid introduction needle is inserted into the liquid outflow path, and is closed when the liquid introduction needle exits from the liquid outflow path, and a flow path closing member disposed in the liquid outflow path, and the flow path closing member is separably fixed to the liquid outlet-forming portion, is positioned downstream of the valve in a liquid outflow direction of the liquid outflow path, and has a groove or recess directed downstream in the liquid outflow direction.

According to a third aspect of the present disclosure, a liquid replenishment container is provided. The liquid replenishment container is a liquid replenishment container that replenishes a liquid in a liquid ejecting apparatus including a liquid introduction needle via the liquid introduction needle, the liquid replenishment container including: a container body portion having an opening and configured to contain the liquid; and a liquid outlet-forming portion including a cylindrical portion that defines a liquid outflow path communicating with the opening, in which the liquid outlet-forming portion includes a valve disposed in the liquid outflow path and opened by the liquid introduction needle inserted into the liquid outflow path, and a flow path closing member disposed in the liquid outflow path in such a way as to be removable to the outside.

### BRIEF DESCRIPTION OF THE DRAWINGS

FIG. 1 is a perspective view of a printer in a first embodiment.

FIG. 2 is a perspective view illustrating a state in which an ink replenishment container is used to replenish ink in an ink tank.

FIG. 3 is a cross-sectional view illustrating a part of the ink replenishment container according to the first embodiment.

FIG. 4 is an enlarged view of a portion surrounded by a broken line in FIG. 3.

FIG. 5 is an exploded perspective view illustrating a part of an internal configuration of the ink replenishment container.

FIG. 6 is a perspective view illustrating an assembled valve unit.

FIG. 7 is a cross-sectional view illustrating a part of an ink replenishment container according to a second embodiment.

FIG. 8 is an enlarged perspective view of a portion surrounded by a broken line in FIG. 7.

FIG. 9 is a perspective view of an ink outlet-forming portion of the ink replenishment container with a cap portion removed, when viewed obliquely from above.

FIG. 10 is an exploded perspective view illustrating a part of an internal configuration of the ink outlet-forming portion.

FIG. 11 is a cross-sectional view illustrating a part of an ink replenishment container according to a third embodiment.

FIG. 12 is an enlarged perspective view of a portion surrounded by a broken line in FIG. 11.

FIG. 13 is a perspective view of an ink outlet-forming portion of the ink replenishment container with a cap portion removed, when viewed obliquely from above.

### DESCRIPTION OF EMBODIMENTS

### A. First Embodiment

### A1. Configuration of Printer 100

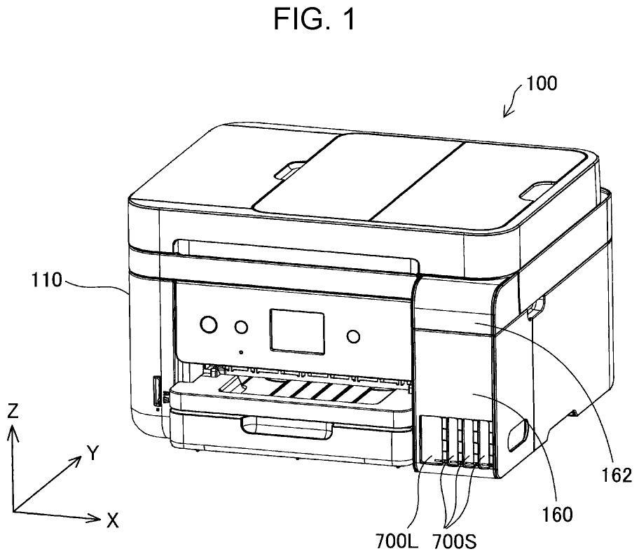

FIG. 1 is a perspective view of a printer 100 in a first embodiment. The printer 100 is an ink jet printer that performs printing by ejecting ink onto a print medium. The printer 100 corresponds to a “liquid ejecting apparatus”. An X axis, a Y axis, and a Z axis orthogonal to each other are depicted in FIG. 1. The X axis corresponds to a width direction of the printer 100, the Y axis corresponds to a depth direction of the printer 100, and the Z axis corresponds to a height direction of the printer 100. The printer 100 is installed on a horizontal installation surface defined by an X direction and a Y direction. Note that an “X-axis direction” refers to a combination of a +X direction and a −X direction. Similarly, a “Y-axis direction” refers to a combination of a +Y direction and a −Y direction, and a “Z-axis direction” refers to a combination of a +Z direction and a −Z direction.

The printer 100 includes a housing 110. A carriage (not illustrated) that is movable in a main scanning direction (X-axis direction) is provided inside the housing 110. A print head that ejects ink onto a print medium is installed on the carriage. An ink tank housing unit 160 that houses a plurality of ink tanks 700S and 700L is provided at one end of a front surface of the housing 110. The ink tank housing unit 160 includes an openable and closable lid 162 provided at an upper portion of the ink tank housing unit 160. The ink tank 700S is a small capacity tank, and the ink tank 700L is a large capacity tank. However, in the following description, the ink tank 700S and the ink tank 700L will be simply referred to as an “ink tank 700” without distinguishing between them.

Each ink tank 700 is coupled to the print head of the carriage by a tube (not illustrated). That is, the ink tank 700 is a stationary ink tank that is not mounted on the carriage of the printer 100. Furthermore, each ink tank 700 is an ink tank of an ink replenishment type that is replenished with ink from an ink replenishment container 1 described below when an ink level decreases. Although the ink tank 700 is a stationary ink tank in the present embodiment, the ink tank 700 may also be an ink tank mounted on the carriage of the printer 100.

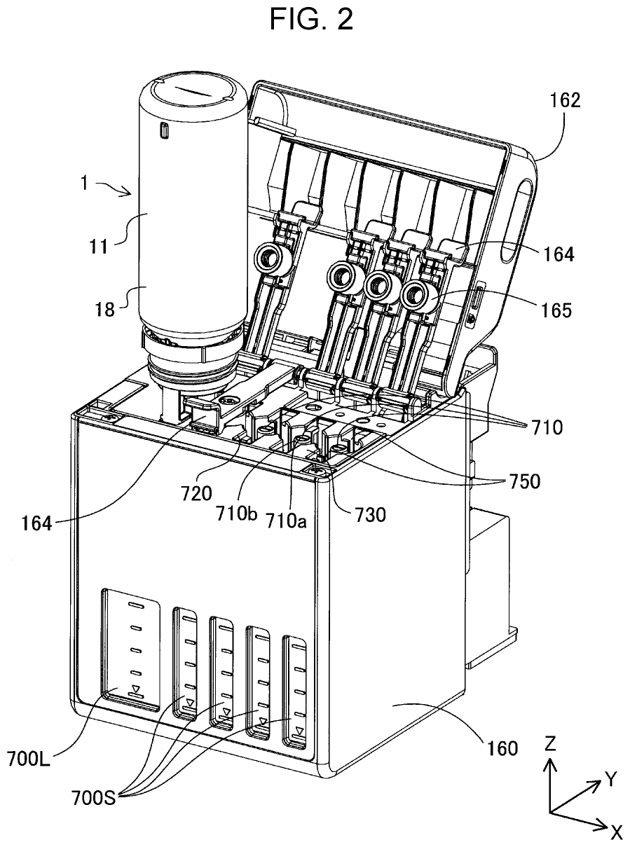

FIG. 2 is a perspective view illustrating a state in which the ink replenishment container 1 is used to replenish ink in the ink tank 700. The ink replenishment container 1 corresponds to a “liquid replenishment container”. A front surface of each ink tank 700 is made of a transparent or semi-transparent material, and the ink level in each ink tank 700 can be visually checked from the outside. When the ink level is low, it is possible to open the lid 162 and replenish ink through a liquid introduction needle 710 of the ink tank 700 as illustrated in FIG. 2.

The cylindrical liquid introduction needle 710 for replenishing ink in the ink tank 700 is provided on an upper surface of each ink tank 700. The ink tank housing unit 160 includes a sealing cap member 164 including a sealing cap 165 for sealing a distal end of the liquid introduction needle 710. When the ink tank 700 is not replenished with ink, the distal end of the liquid introduction needle 710 is sealed with the sealing cap 165 of the sealing cap member 164. When replenishing ink in the ink tank 700, the sealing cap 165 is removed from the liquid introduction needle 710, and a distal end portion of the ink replenishment container 1 is inserted into an ink inlet at which the liquid introduction needle 710 is provided to replenish the ink.

At this time, the ink is supplied from the ink replenishment container 1 to the ink tank 700 via the liquid introduction needle 710. The liquid introduction needle 710 includes a partition wall 710a that partitions the inside of the liquid introduction needle 710 into two flow paths. One of the two flow paths is used for ink to flow in, and the other is used for air to flow out from the ink tank 700 into the inside of the ink replenishment container 1. In a distal end surface of the liquid introduction needle 710 illustrated in FIG. 2, a distal end surface of the partition wall 710a and a distal end surface of a tubular portion 710b are positioned on the same horizontal plane. However, the distal end surface of the partition wall 710a may be positioned higher than the distal end surface of the tubular portion 710b.

In the present specification, the term “ink replenishment” refers to an operation of supplying ink to the ink tank 700 to increase the ink level. However, it is not necessary to fill the ink tank 700 full with ink by “ink replenishment”. Furthermore, “ink replenishment” includes an operation of filling the empty ink tank 700 with ink when the printer 100 is used for the first time.

### A2. Configuration of Ink Replenishment Container 1

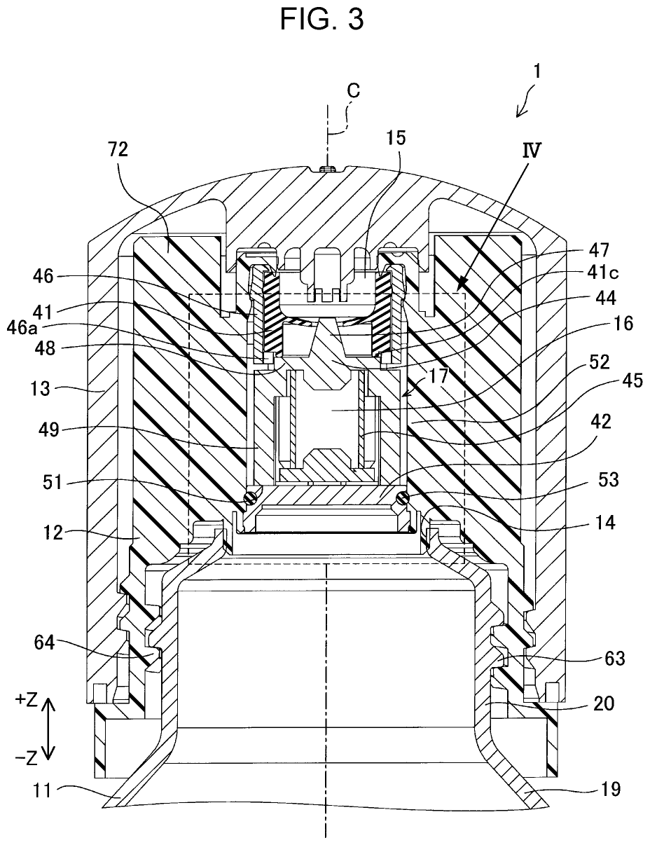

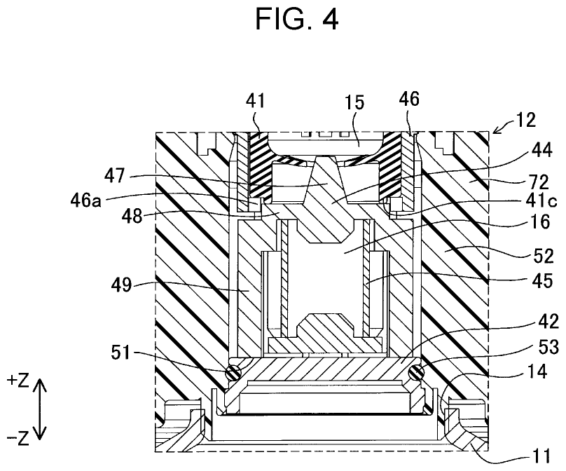

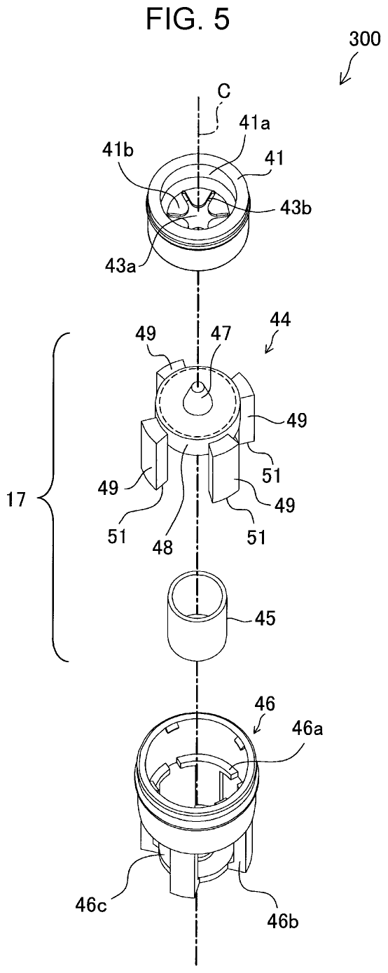

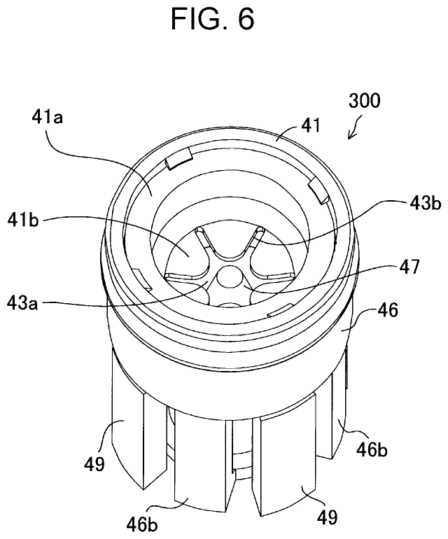

Next, a configuration of the ink replenishment container 1 will be described with reference to FIGS. 3 to 6. FIG. 3 is a cross-sectional view illustrating a part of the ink replenishment container 1 according to the first embodiment. FIG. 3 illustrates an ink outlet-forming portion 12 and a surrounding portion thereof when a cap portion 13 is mounted on the ink replenishment container 1, and illustrates a cross section in a plane passing through a central axis C of the ink replenishment container 1. FIG. 4 is an enlarged view of a portion surrounded by a broken line in FIG. 3. FIG. 5 is an exploded perspective view illustrating a part of an internal configuration of the ink replenishment container 1. FIG. 5 particularly illustrates an internal configuration of the ink outlet-forming portion 12 positioned inside the cap portion 13. FIG. 6 is a perspective view illustrating an assembled valve unit 300.

As illustrated in FIGS. 3 and 4, the ink replenishment container 1 includes a container body portion 11 that has an opening 14 and is capable of containing ink therein, the ink outlet-forming portion 12 coupled to the container body portion 11, and the cap portion 13 mounted on the ink outlet-forming portion 12. The ink replenishment container 1 has a cylindrical bottle shape as a whole (see FIG. 2). In the following description of the ink replenishment container 1, a vertical direction of the ink replenishment container 1 standing alone on a horizontal plane is defined as a height direction, and the vertical direction illustrated in FIG. 3 is referred to as a “vertical direction”. In the ink replenishment container 1, the ink outlet-forming portion 12 and the cap portion 13 are positioned on an upper side of the container body portion 11.

The ink outlet-forming portion 12 is a portion for dispensing ink from the inside of the container body portion 11 to the outside, the portion having an ink outlet 15 for dispensing ink contained in the container body portion 11. The ink outlet-forming portion 12 is made of a resin. The ink outlet-forming portion 12 corresponds to a “liquid outlet-forming portion”. An ink outflow path 16 is formed within a cylindrical portion 52 of the ink outlet-forming portion 12 described below. The ink outflow path 16 corresponds to a “liquid outflow path”, communicates with the opening 14, and includes the ink outlet 15 at a downstream end of the ink outflow path 16 in an ink outflow direction. In other words, the ink outflow path 16 is an internal space defined by the cylindrical portion 52, and when a member defining a space is added to a distal end of the cylindrical portion 52 that is adjacent to the ink outlet 15, the ink outflow path 16 also includes the internal space. The ink outlet-forming portion 12 includes a sealing member 41, a spring valve 17, and an inner plug 42. The sealing member 41, the spring valve 17, and the inner plug 42 are arranged with the central axes C aligned.

The sealing member 41 is made of an elastic material such as rubber or elastomer, and is disposed within the ink outlet 15. The sealing member 41 includes a sealing member cylindrical portion having the central axis C. Further, the sealing member 41 includes a wing-like portion 41b that extends in a radial direction from an inner circumferential wall 41a of the sealing member cylindrical portion toward the central axis C and has an arcuate cross section in a central axis direction. The wing-like portion 41b is formed in the form of each elastic piece divided by a slit 43b extending in a radiation direction or the radial direction from a through hole 43a formed at the center of a dome-shaped elastic membrane portion toward the inner circumferential wall 41a of the sealing member cylindrical portion.

The slit 43b may be a single slit extending diametrically through the through hole 43a. In a valve-closed state, a distal end of a valve body 44 described below is inserted into the through hole 43a, the valve body 44 being urged in a closing direction (upward). Further, in the valve-closed state, an upper surface of a disc portion 48 of the valve body 44 (a portion indicated by a circular broken line in FIG. 5) described below comes into close contact with an annular protruding portion 41c formed on a lower end surface of the sealing member 41. Therefore, in the ink outflow path 16, a space inside the inner circumferential wall 41a of the sealing member 41 and a space upstream of the internal space in the ink outflow direction are isolated from each other.

The spring valve 17 is disposed in the ink outflow path 16 of the ink outlet-forming portion 12. In the spring valve 17, a spring member 45 pushes the valve body 44 toward the sealing member 41 in a non-replenishment state in which ink is not replenished in the ink tank 700. As a result, the spring valve 17 is in a valve-closed state in which the valve body 44 comes into contact with the sealing member 41, which makes it difficult for ink to leak to the outside. In a replenishment state in which ink is replenished in the ink tank 700, the ink replenishment container 1 is coupled to the liquid introduction needle 710 of the printer 100 in an upside-down position with the ink outlet 15 facing downward as illustrated in FIG. 2.

The liquid introduction needle 710 pushes the valve body 44 against an urging force of the spring member 45 of the spring valve 17 to form a gap between the valve body 44 and the sealing member 41, thereby allowing ink to flow through the ink outflow path 16. At this time, the partition wall 710a of the liquid introduction needle 710 pushes a truncated cone portion 47 of the valve body 44, the tubular portion 710b pushes the wing-like portion 41b, and the through hole 43a and the slit 43b are expanded to open the spring valve 17. As a result, ink flows from the ink outflow path 16 into the liquid introduction needle 710. The spring valve 17 is a normally closed valve.

In the present embodiment, the spring valve 17 includes at least the valve body 44, the spring member 45, and a contact portion 51, and these members are held by a holder portion 46. Furthermore, in the present embodiment, the holder portion 46 also holds the sealing member 41, and the valve unit 300 includes the spring valve 17, the sealing member 41, and the holder portion 46. The valve unit 300 is engaged with the cylindrical portion 52. The valve body 44 includes the truncated cone portion 47, the disc portion 48, and a side wall portion 49 arranged in this order from an ink outlet 15 side. The valve body 44 including the disc portion 48, and the side wall portion 49 may be provided as separate members in order to facilitate assembly. Alternatively, the holder portion 46 may be divided into two parts in the vertical direction.

When the ink outlet 15 is directed upward, that is, in the +Z direction, the truncated cone portion 47 is a truncated-cone-shaped portion that is provided at the center of the upper surface of the disc portion 48 and protrudes upward, and in the valve-closed state, an upper end of the truncated cone portion 47 protrudes upward from the through hole 43a of the sealing member 41. In a valve-open state, a distal end of the partition wall 710a of the liquid introduction needle 710 of the printer 100 comes into contact with a distal end surface of the truncated cone portion 47. Further, in the valve-closed state, a distal end surface of the disc portion 48 comes into close contact with the annular protruding portion 41c formed on the lower end surface of the sealing member 41 to close the ink outflow path 16. The side wall portion 49 is a columnar member of which a cross section in a horizontal plane orthogonal to the central axis C forms a part of an annular shape (a center angle of approximately) 20° and which extends downward from an outer circumferential surface of the disc portion 48. In the present embodiment, there are four side wall portions 49, which are provided at approximately equal intervals of 90 degrees in a circumferential direction of the disc portion 48. The side wall portion 49 extends from the valve body 44 toward the container body portion 11 in a direction along the central axis C of the cylindrical portion 52.

In the present embodiment, the valve unit 300 has a configuration in which the spring valve 17 and the sealing member 41 are held inside the holder portion 46. The valve unit is disposed inside the cylindrical portion 52 and is detachably engaged with the cylindrical portion 52. The valve unit 300 may have a configuration in which the sealing member 41, the valve body 44, and the spring member 45 are each engaged with the cylindrical portion 52 without using the holder portion 46, instead of the configuration in which the sealing member 41, the valve body 44, and the spring member 45 are held by the holder portion 46. Alternatively, the sealing member 41 may be individually engaged with the cylindrical portion 52, and the valve body 44 and the spring member 45 may be engaged with the cylindrical portion 52 while being held by the holder portion 46. Various combinations are possible in the present embodiment. For example, the sealing member 41 may be held by the holder portion 46 and engaged with the cylindrical portion 52, and the valve body 44 and the spring member 45 may be individually engaged with the cylindrical portion 52.

The spring member 45 is a cylindrical coil spring and is provided on a lower surface of the disc portion 48 of the valve body 44 and on inner sides of the four side wall portions 49 in the radial direction. The spring member 45 urges the valve body 44 toward the sealing member 41 in the valve-closed state.

The contact portion 51 is a portion formed on an end surface (lower end surface) of the side wall portion 49 that is adjacent to the inner plug 42 in an axial direction, that is, the end surface of the side wall portion 49 that faces the inner plug 42. In the present embodiment, the side wall portion 49 is formed integrally with the valve body 44. Therefore, the contact portion 51 is formed integrally with the valve body 44 and comes into contact with the inner plug 42 at least when the valve 17 is in the valve-open state. The contact portion 51 functions as a portion that moves toward the container body portion 11 in conjunction with the valve body 44 in the valve-open state, and pushes the inner plug 42 toward the container body portion 11. Note that the contact portion 51 may be in contact with the inner plug 42 not only in the valve-open state but also in the valve-closed state. The holder portion 46 houses the sealing member 41, the spring member 45, and the valve body 44 therein.

The holder portion 46 includes a protrusion 46a formed along an inner circumferential wall and on which the sealing member 41 is mounted. Accordingly, when the liquid introduction needle 710 is inserted into an inner space of the sealing member 41, movement of the liquid introduction needle 710 in an insertion direction is restricted. Further, the holder portion 46 includes four pillars 46b that movably hold the valve body 44 along the central axis C, and a spring member support portion 46c that supports the spring member 45. The pillars 46b have outer surfaces shaped along an inner circumferential surface of the cylindrical portion 52, and a gap space penetrating in the radial direction is formed between adjacent pillars 46b. The gap space has a function of allowing air flowing in from the ink tank 700 to flow toward an inner wall of the cylindrical portion 52 positioned outward in the radial direction from the central axis C and allowing ink flowing out from the container body portion 11 to flow from the inner wall of the cylindrical portion 52 toward the center axis C positioned inward in the radial direction, so that ink and air can be easily separated in the valve-open state. However, in the present embodiment, the side wall portion 49 is disposed in the gap space.

The ink outlet-forming portion 12 is provided with a pair of identification structure portions 72 arranged to interpose the cylindrical portion 52 therebetween in the radial direction. The identification structure portion 72 has a different shape depending on the type of ink contained in the ink replenishment container 1, and is used to appropriately replenish a type of ink corresponding to the ink in the ink tank 700.

The cylindrical portion 52 is coupled to the opening 14 of the container body portion 11. The inner plug 42 is positioned between the spring valve 17 and the opening 14 in a direction along the central axis C, and is engaged with the cylindrical portion 52 via a seal ring 53. The inner plug 42 is a cap-like member having a cylindrical shape with a bottom, and corresponds to a flow path closing member that closes the ink outflow path 16. When the ink replenishment container 1 is used for the first time, the ink replenishment container 1 is coupled to the liquid introduction needle 710 of the printer 100 as illustrated in FIG. 2. Since the liquid introduction needle 710 presses the valve body 44, the inner plug 42 is pressed by the contact portion 51. As a result, the inner plug 42 is separated from the ink outlet-forming portion 12 and falls into the container body portion 11.

The cap portion 13 is mounted on an outer circumference of the ink outlet-forming portion 12, covers the ink outlet-forming portion 12, and shields the inside of the container body portion 11 from the outside air. The cap portion 13 can be attached to and detached from the ink outlet-forming portion 12 by threaded engagement.

As illustrated in FIGS. 2 and 3, the container body portion 11 includes a cylindrical large diameter portion 18 having a bottom on a side opposite to the opening 14 in the direction along the central axis C. The container body portion 11 occupies approximately ½ or more and ⅔ or less of a length of the ink replenishment container 1 in the direction along the central axis C, and serves as a body portion of the ink replenishment container 1.

The ink outlet-forming portion 12 is coupled to an upper end of the container body portion 11. The ink outlet-forming portion 12 is made of a resin. The container body portion 11 includes, in order from the bottom, the large diameter portion 18 (see FIG. 2), a reduced diameter portion 19 coupled to the large diameter portion 18 and whose diameter gradually decreases, and a small diameter portion 20 having a constant diameter and coupled to an upper end of the reduced diameter portion 19 that has a reduced diameter. The diameter of the small diameter portion 20 is smaller than a diameter of a lower end of the ink outlet-forming portion 12, and the ink outlet-forming portion 12 is coupled to an outer side of the container body portion 11. A male threaded portion 63 is formed on an outer circumference of the small diameter portion 20 of the container body portion 11 and protrudes outward in the radial direction.

When assembling the ink outlet-forming portion 12 to the container body portion 11, a female threaded portion 64 of the ink outlet-forming portion 12 is engaged with the male threaded portion 63 of the container body portion 11 by threaded engagement. Thereby, the ink outlet-forming portion 12 and the container body portion 11 are coupled to each other. Coupling and fixation between the ink outlet-forming portion 12 and the container body portion 11 are not limited to threaded engagement, and may also be made by claw engagement, a combination with a ratchet structure to restrict movement in the circumferential direction, fixing using a film, a tape, or an adhesive, welding, or the like. For example, in a case in which the ink outlet-forming portion 12 and the container body portion 11 are fixed by a ratchet structure or the like, it is easy to prevent the ink outlet-forming portion 12 from rotating and being separated from the container body portion 11 when a user rotates and removes the cap portion 13.

With the ink replenishment container 1 according to the first embodiment described above, the following effects can be achieved.

According to the first embodiment, in the ink replenishment container 1 including the spring valve 17, the spring valve 17 includes the contact portion 51 that presses the inner plug 42 when the valve body 44 is pushed from the ink outlet 15 side. Therefore, the inner plug 42 is separated by a pressure from the liquid introduction needle 710, allowing ink to flow through the ink outflow path 16. With this configuration, even when the ink replenishment container 1 is in the upside-down position, ink can be prevented from leaking to the outside from the container body portion 11 until the liquid introduction needle 710 is inserted into the ink outflow path 16.

Further, compared to a slit valve, the spring valve 17 is difficult to open even when subjected to an impact or when the inside of the ink replenishment container 1 is pressurized. Therefore, even after the inner plug 42 is separated when the ink replenishment container 1 is used for the first time, ink leakage is unlikely to occur even when performing the second and subsequent ink injection operations using the remaining ink in the ink replenishment container 1.

According to the first embodiment, the contact portion 51 is formed integrally with the valve body 44, and thus, the contact portion 51 is urged toward the ink outlet 15 by the spring member 45. Therefore, even when the ink replenishment container 1 is subjected to some kind of impact before being coupled to the liquid introduction needle 710, the inner plug 42 is unlikely to be separated. In addition, the contact portion 51 is formed on the end surface of the side wall portion 49 in the axial direction, the side wall portion 49 being formed in the axial direction and the end surface being adjacent to the inner plug 42 in the axial direction. Therefore, when the valve body 44 is pushed by the ink introduction needle, the inner plug 42 can be properly pushed toward the container body portion 11 and separated by being guided by the cylindrical portion 52.

### B. Second Embodiment

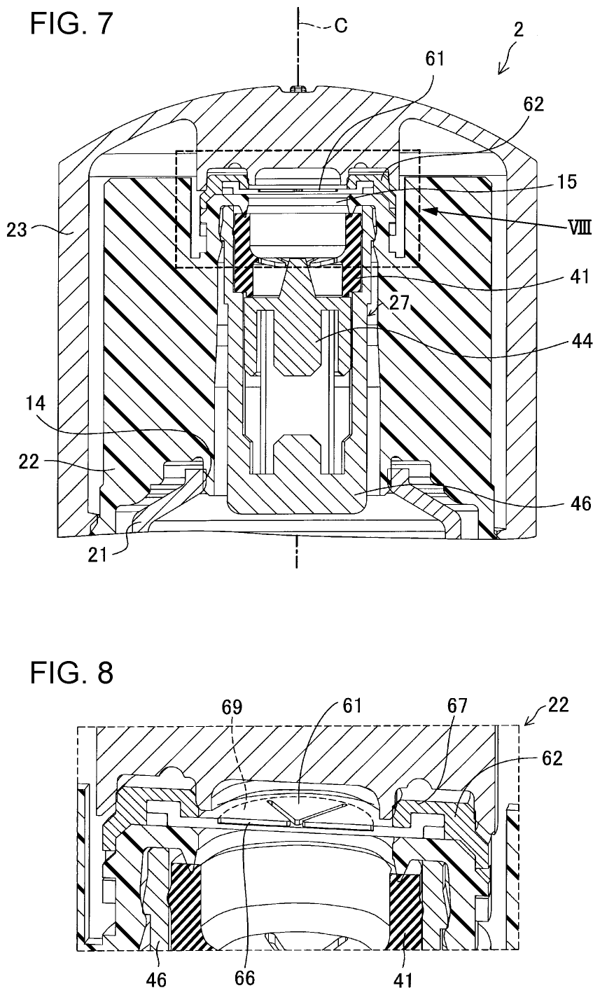

Next, an ink replenishment container 2 according to a second embodiment of the present disclosure will be described with reference to FIGS. 7 to 10. In multiple embodiments described below, substantially similar configurations to those in the first embodiment are denoted by the same reference signs, and a description thereof will be omitted. FIG. 7 is a cross-sectional view illustrating a part of the ink replenishment container 2 according to the second embodiment. FIG. 7 illustrates a main part of an ink outlet-forming portion 22 and a surrounding portion thereof when a cap portion 23 of the ink replenishment container 2 is mounted, and illustrates a cross section in a plane passing through a central axis C. FIG. 8 is an enlarged perspective view of a portion surrounded by a broken line in FIG. 7.

The ink replenishment container 2 according to the second embodiment is similar to that of the first embodiment in that the ink replenishment container 2 includes a container body portion 21, the ink outlet-forming portion 22, and the cap portion 23, and the ink replenishment container 2 according to the second embodiment is different from that of the first embodiment in an internal configuration of the ink outlet-forming portion 22. The ink replenishment container 2 according to the second embodiment does not include the inner plug 42 and includes a half-slit component 61 as the flow path closing member, which will be described in detail below. As illustrated in FIGS. 7 and 8, the half-slit component 61 is provided inside the ink outlet-forming portion 22 via a holding member 62 at an upper portion near an ink outlet 15.

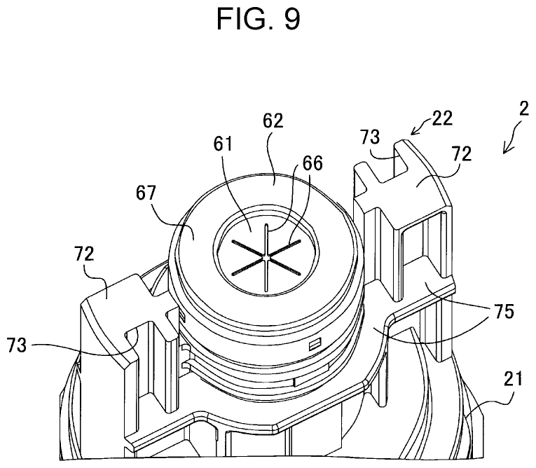

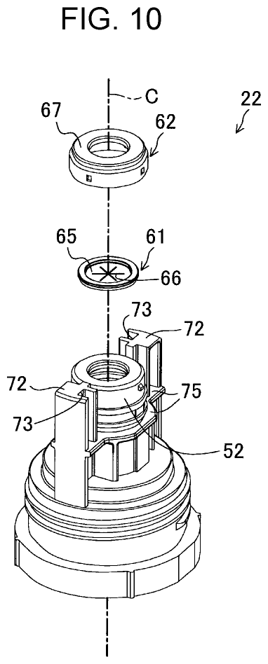

FIG. 9 is a perspective view of the ink outlet-forming portion 22 when viewed obliquely from above in the ink replenishment container 2 in a state in which the cap portion 23 is removed and the ink outlet 15 is directed upward, that is, in a +Z direction. FIG. 10 is an exploded perspective view illustrating a part of the internal configuration of the ink outlet-forming portion 22. As illustrated in FIGS. 9 and 10, the half-slit component 61 has a disc shape. A recess 65 recessed downward and having a circular shape in plan view is formed on an upper surface of the half-slit component 61. A liquid introduction needle 710 is inserted into the “upper surface” when replenishing ink. Six slit-shaped grooves 66 are formed at a bottom of the recess 65. The groove 66 is a thin portion having a thickness smaller than that of other portions of the bottom of the recess 65, and does not penetrate through the bottom in a thickness direction.

The groove 66 does not need to have a slit shape, and may be a simple recess. That is, the entire radially inner region in a range surrounded by a dotted line as a thin recess range 69 in FIG. 8 may be formed to be thin. The thin recess range 69 is in the inside of a circle whose radius corresponds to the groove 66 in plan view. Furthermore, the groove 66 and the thin recess range 69 are directed downstream in an ink outflow direction, and the thicknesses of the groove 66 and the bottom of the thin recess range 69 are smaller than that of other portions.

Note that the “thickness” here refers to a direction along the ink outflow direction and a thickness in a direction along the central axis C of the ink replenishment container 2. The “ink outflow direction” refers to a direction in which ink flows from the container body portion 21 to an ink tank 700 via the ink outlet-forming portion 22 during ink replenishment. The grooves 66 extend outward in a radial direction from the center of the bottom of the recess 65, and six grooves 66 are radially arranged at approximately equal intervals in a circumferential direction. The grooves 66 are not limited to a plurality of diametrical grooves having an intersection at the center as in the present embodiment, and may be one groove diametrically extending through the center. The half-slit component 61 is broken when the liquid introduction needle 710 is inserted from above in FIGS. 7 to 10 in the vicinity of the center of the recess 65, thereby allowing communication between an ink outflow path 16 of the ink outlet-forming portion 22 and a flow path inside the liquid introduction needle 710 of a printer 100.

The half-slit component 61 is removably attached to the ink outlet-forming portion 22 by being covered with the holding member 62 from above. The holding member 62 has a cylindrical shape. The holding member 62 includes a flange portion 67 extending inward (toward the central axis C) and formed on an outflow side, that is, an upper edge of the holding member 62 in FIGS. 7 to 10. An opening is formed on a radially inner side of the flange portion 67, and a portion of the half-slit component 61 where the grooves 66 are formed is exposed through the opening. The half-slit component 61 is positioned downstream of a spring valve 27 (see FIG. 7) in the ink outflow direction. Although shapes of a valve body 44 and a holder portion 46 of the spring valve 27 are partially different from those of the spring valve 27 according to the first embodiment, the spring valves 27 are members that have substantially the same function and are thus denoted by the same reference sign.

The half-slit component 61 is separably fixed to the ink outlet-forming portion 22 via the holding member 62. As the recess 65 is formed, an annular protrusion is formed at an outer circumferential edge of the half-slit component 61. The annular protrusion is held and fixed by the flange portion 67 of the holding member 62 from above (see FIG. 8).

The holding member 62 is a member that is fixed to an ink outflow side end of the ink outlet-forming portion 22 as a separate member from the half-slit component 61. The holding member 62 is hooked on the ink outflow side to be removed, thereby making it possible to remove the half-slit component 61 from the ink outlet-forming portion 22. Coupling between the container body portion 21 and the ink outlet-forming portion 22 and coupling between the ink outlet-forming portion 22 and the cap portion 23 are similar to those in the first embodiment. The holding member 62 corresponds to a “fixing member”.

According to the second embodiment, similar effects to those of the ink replenishment container 1 according to the first embodiment are achieved. In addition, even when the ink replenishment container 2 is in an upside-down position, the half-slit component 61 can prevent ink from leaking until the liquid introduction needle 710 penetrates through the half-slit component 61. Further, since the half-slit component 61 is separably fixed to the ink outlet-forming portion 22 via the holding member 62, it is easy to reuse the ink replenishment container 2, replace the half-slit component 61, and the like. Moreover, when reusing the ink replenishment container 2, the holding member 62 can be reused, and only the penetrated half-slit component 61 needs to be replaced. Further, each groove 66 is formed in the half-slit component 61, so that the liquid introduction needle 710 can easily penetrate through the half-slit component 61.

### C. Third Embodiment

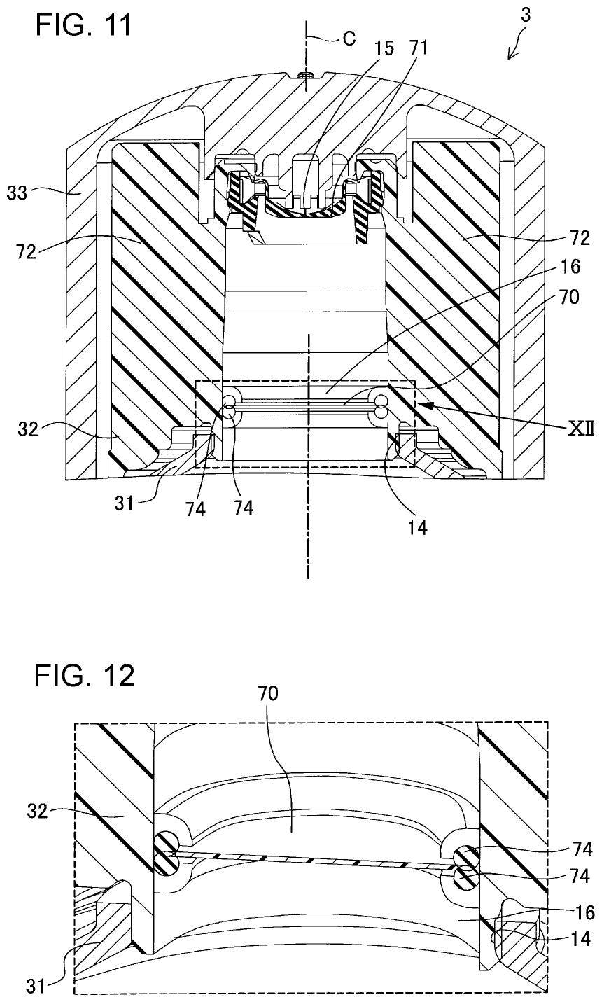

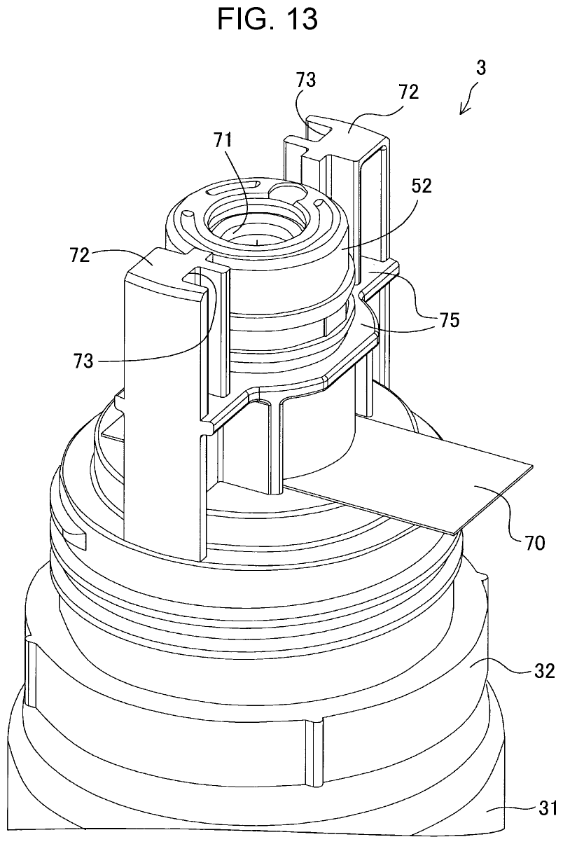

Next, an ink replenishment container 3 according to a third embodiment of the present disclosure will be described with reference to FIGS. 11 to 13. FIG. 11 is a cross-sectional view illustrating a part of the ink replenishment container 3 according to the third embodiment. FIG. 11 illustrates a main part of an ink outlet-forming portion 32 on which a cap portion 33 of the ink replenishment container 3 is mounted and a surrounding portion thereof, and illustrates a cross section in a plane passing through a central axis C. FIG. 12 is an enlarged perspective view of a portion surrounded by a broken line in FIG. 11.

The ink replenishment container 3 according to the third embodiment is similar to that of the first embodiment in that the ink replenishment container 3 includes a container body portion 31, the ink outlet-forming portion 32, and the cap portion 33, and the ink replenishment container 3 according to the third embodiment is different from that of the first embodiment in an internal configuration of the ink outlet-forming portion 32. The ink replenishment container 3 according to the third embodiment does not include the inner plug 42 and includes a partition component 70 as the flow path closing member. Further, in the third embodiment, a well-known slit valve 71 is provided at an ink outlet 15 instead of the spring valve 17, which will be described in detail below.

FIG. 13 is a perspective view of the ink outlet-forming portion 32 of the ink replenishment container 3 with the cap portion 33 removed, when viewed obliquely from above. As illustrated in FIG. 13, the ink outlet-forming portion 32 includes a pair of identification structure portions 72 for identifying the type of ink, the identification structure portions 72 being arranged to interpose, therebetween in a radial direction, a cylindrical portion 52 in which an ink outflow path 16 is formed. The radial direction means a direction orthogonal to the central axis C of the ink outflow path 16. The pair of identification structure portions 72 are each inserted into an identification recess 720 provided in an adapter portion of an ink tank 700. A linear identification groove 73 is formed on a side surface of the identification structure portion 72 from a distal end side to a rear end side. A location where the identification groove 73 is formed differs depending on the ink replenishment container 3.

As illustrated in FIGS. 11 to 13, the rectangular plate-shaped partition component 70 is disposed above an opening 14 of the container body portion 31 to close the opening 14 inside the ink outlet-forming portion 32. The partition component 70 is, for example, a plate made of a resin such as plastic. The partition component 70 is fixed to the cylindrical portion 52 while being clamped from above and below by two O-rings 74 (see FIGS. 11 and 12) disposed in the ink outflow path 16. The O-ring 74 corresponds to an “elastic sealing member”. An end portion of the partition component 70 in the radial direction protrudes outward in the radial direction from the cylindrical portion 52. The end portion of the partition component 70 in the radial direction is positioned at a position that does not overlap in a circumferential direction with a portion where the pair of identification structure portions 72 are positioned. In the present embodiment, a line in which the pair of identification structure portions 72 are arranged in the radial direction and a line in a longitudinal direction in which the partition component 70 extends in the radial direction are substantially orthogonal to each other in plan view. Note that the lines may intersect each other at an angle other than 90°.

With a clamping force of the O-rings 74, the removal of the partition component 70 to the outside can be performed by pulling the end portion of the partition component 70 in the radial direction outward in the radial direction. Therefore, when the ink replenishment container 3 is mounted on a printer 100 in an ink replenishment state illustrated in FIG. 2, that is, a valve-open state, a user or the like of the printer 100 can remove the partition component 70 to the outside by pulling the end portion of the partition component 70 in the radial direction outward in the radial direction.

Further, as illustrated in FIG. 13, the ink outlet-forming portion 32 includes a positioning portion 75. The positioning portion 75 is a plate-like portion having an arc-shaped portion positioned on a radially outer side of the cylindrical portion 52 in plan view, and linear portions parallel to a diameter of the cylindrical portion 52 in plan view positioned on left and right sides of the identification structure portions 72. The positioning portion 75 has a plane orthogonal to the central axis C. When the identification structure portion 72 of the ink replenishment container 3 is properly engaged with the corresponding identification recess 720, a liquid introduction needle 710 is inserted into the cylindrical portion 52. In the ink replenishment state illustrated in FIG. 2, when the identification recess 720 of the printer 100 and the identification structure portion 72 of the ink replenishment container 3 are properly engaged with each other, the ink outlet-forming portion 32 is coupled to the liquid introduction needle 710, the positioning portion 75 is supported in contact with a receiving plane 730 extending in a direction intersecting the liquid introduction needle 710 at a position slightly above the liquid introduction needle 710, so that the ink replenishment container 3 is positioned in an insertion direction, that is, a Z direction.

The partition component 70 is positioned below the positioning portion 75 in a direction along an ink outflow direction, that is, on a side adjacent to the container body portion 31, in the state illustrated in FIGS. 11 to 13. Therefore, after the ink replenishment container 3 is mounted on the printer 100 as illustrated in FIG. 2, the liquid introduction needle 710 is inserted into the cylindrical portion 52, the positioning portion 75 comes into contact with the receiving plane 730 to position the ink replenishment container 3, the partition component 70 can be slid and removed.

According to the third embodiment, similar effects to those of the ink replenishment container 1 according to the first embodiment are achieved. In addition, when the ink replenishment container 3 is used for the first time, the ink outflow path 16 can be closed until the partition component 70 is removed, which makes it easy to avoid ink leakage. Furthermore, for example, after the ink replenishment container 3 is mounted on the printer 100 in an upside-down position, the ink outflow path 16 can be opened at any timing intended by the user, which is convenient for the user.

Further, when reusing the ink replenishment container 3, there is no need to remove the partition component 70 from the inside of the ink replenishment container 3, which makes reuse easy. The partition component 70 is positioned below the positioning portion 75 in the state illustrated in FIG. 11. That is, in the ink replenishment state illustrated in FIG. 2, the partition component 70 is positioned above the positioning portion 75, so that the partition component 70 does not get in the way when the ink replenishment container 3 is mounted on the printer 100 in the upside-down position, and the user can easily remove the protruding end portion in the radial direction.

### D. Other Embodiments

(D1) In the first embodiment, the contact portion 51 is a portion extending from the valve body 44 toward the container body portion 11 and formed on the end surface of each of the four side wall portions 49 that is adjacent to the inner plug in the axial direction, the four side wall portions 49 being formed in the axial direction of the cylindrical portion 52. Alternatively, the four side wall portions 49 may be configured as a circumferential wall that is continuous in the circumferential direction. That is, the contact portion 51 may be formed on an end surface of each of portions that are not continuous in the circumferential direction and have a columnar shape in the central axis direction as in the first embodiment, or may be formed on an end surface of the circumferential wall portion that is continuous in the circumferential direction. Furthermore, the contact portion 51 only needs to be able to move in conjunction with the valve body 44, and does not need to be configured integrally with the valve body 44. Further, when the side wall portion 49 including the contact portion 51 is configured separately from the valve body 44, the side wall portion 49 only needs to move in conjunction with the valve body 44 at least in the valve-open state, and the side wall portion 49 does not have to move in conjunction with the valve body 44 in the valve-closed state. However, in the valve-open state, when the valve body 44 is pushed by the liquid introduction needle 710, the side wall portion 49 needs to press the inner plug 42 in conjunction with the valve body 44.

(D2) In the second embodiment, the holding member 62 for fixing the half-slit component 61 does not have to be provided. In this configuration, for example, the holding member 62 can be integrated with the half-slit component 61, and it is sufficient that the half-slit component 61 is separable from the ink outlet-forming portion 22.

(D3) In the second embodiment, the slit valve 71 as illustrated in FIG. 11 may be used instead of the spring valve 17. Further, in the third embodiment, the spring valve 17 may be used instead of the slit valve 71.

(D4) In the third embodiment, the partition component 70 does not have to be clamped between the O-rings 74 serving as the elastic sealing members. Furthermore, the partition component 70 may be provided downstream of the positioning portion 75 in a direction along the ink outflow direction.

The present disclosure is not limited to the embodiments described above, and can be implemented in various configurations without departing from the scope of the present disclosure. For example, the technical features in the above embodiments corresponding to the technical features in each form described in the “Summary” section can be appropriately replaced or combined to solve some or all of the above-described problems or to achieve some or all of the above-described effects. Further, when the technical features are not described as essential in the present specification, the technical features can be deleted as appropriate.

(1) According to one aspect of the present disclosure, a liquid replenishment container is provided. The liquid replenishment container is a liquid replenishment container that replenishes a liquid in a liquid ejecting apparatus including a liquid introduction needle via the liquid introduction needle, the liquid replenishment container including: a container body portion having an opening and configured to contain the liquid; and a liquid outlet-forming portion coupled to the container body portion and including a cylindrical portion that defines a liquid outflow path communicating with the opening, in which the liquid outlet-forming portion includes a sealing member disposed in the liquid outflow path, a valve disposed in the liquid outflow path, and a flow path closing member disposed in the liquid outflow path between the opening and the valve, the valve includes a spring member, a valve body that comes into contact with the sealing member by being urged by the spring member in a valve-closed state and is separated from the sealing member by being pressed by the liquid introduction needle inserted into the liquid outflow path in a valve-open state, and a contact portion that moves in conjunction with the valve body at least in the valve-open state and comes into contact with the flow path closing member, and the flow path closing member is an inner plug that is engaged with the liquid outlet-forming portion, the inner plug configured to be disengaged from the liquid outlet-forming portion by being pressed by the liquid introduction needle via the valve when the liquid replenishment container is used for the first time.

According to the aspect, even when the liquid replenishment container includes a spring valve including a spring member, the spring valve includes the contact portion that moves in conjunction with the valve body and comes into contact with the flow path closing member, and thus, the inner plug is removed by a pressure from the liquid introduction needle and the liquid outflow path is opened. Therefore, even when the liquid replenishment container is in the upside-down position in which the liquid outlet-forming portion is positioned below the container body portion, or the liquid replenishment container is in a tilted position, liquid leakage is prevented until the liquid introduction needle is inserted.

Furthermore, compared to a slit valve, the spring valve is more difficult to open even when subjected to an impact or when the inside of the container is pressurized, and thus, even after the flow path closing member is separated when the liquid replenishment container is used for the first time, liquid leakage is unlikely to occur when performing the second and subsequent liquid injection operations using the remaining liquid in the liquid replenishment container.

(2) In the liquid replenishment container according to the aspect, the valve body may include a side wall portion integrally formed with the valve body and extending in an axial direction of the cylindrical portion, and the contact portion may be formed on an end surface of the side wall portion in the axial direction.

According to the aspect, the contact portion is formed integrally with the valve body, and thus, the contact portion is urged toward a liquid outlet by the spring member. Therefore, even when the liquid replenishment container is subjected to some kind of impact before being coupled to the liquid introduction needle, the flow path closing member is unlikely to be separated. Further, the contact portion is formed on the end surface of the side wall portion in the axial direction, the side wall portion being formed in the axial direction. Therefore, when the valve body is pushed by the liquid introduction needle, the flow path closing member can be properly pushed and separated by being guided by the cylindrical portion.

(3) According to a second aspect of the present disclosure, a liquid replenishment container is provided. The liquid replenishment container is a liquid replenishment container that replenishes a liquid in a liquid ejecting apparatus including a liquid introduction needle via the liquid introduction needle, the liquid replenishment container including: a container body portion having an opening and configured to contain the liquid; and a liquid outlet-forming portion including a cylindrical portion that defines a liquid outflow path communicating with the opening, in which the liquid outlet-forming portion includes a valve that is disposed in the liquid outflow path, is opened when the liquid introduction needle is inserted into the liquid outflow path, and is closed when the liquid introduction needle exits from the liquid outflow path, and a flow path closing member disposed in the liquid outflow path, and the flow path closing member is separably fixed to the liquid outlet-forming portion, is positioned downstream of the valve in a liquid outflow direction of the liquid outflow path, and has a groove or recess directed downstream in the liquid outflow direction.

According to the aspect, even when the liquid replenishment container is in the upside-down position or tilted position, liquid leakage is prevented until the liquid introduction needle is inserted. Further, since the flow path closing member is separably fixed to the liquid outlet-forming portion, it is easy to reuse the liquid replenishment container, replace the flow path closing member, and the like.

(4) In the liquid replenishment container according to the aspect, the flow path closing member may be detachably attached to a downstream end portion of the liquid outlet-forming portion in the liquid outflow direction by a separate fixing member. According to the aspect, when reusing the liquid replenishment container, the fixing member can be reused, and only the penetrated flow path closing member needs to be replaced.

(5) According to a third aspect of the present disclosure, a liquid replenishment container is provided. The liquid replenishment container is a liquid replenishment container that replenishes a liquid in a liquid ejecting apparatus including a liquid introduction needle via the liquid introduction needle, the liquid replenishment container including: a container body portion having an opening and configured to contain the liquid; and a liquid outlet-forming portion including a cylindrical portion that defines a liquid outflow path communicating with the opening, in which the liquid outlet-forming portion includes a valve disposed in the liquid outflow path and opened by the liquid introduction needle inserted into the liquid outflow path, and a flow path closing member disposed in the liquid outflow path in such a way as to be removable to the outside.

According to the aspect, when the liquid replenishment container is used for the first time, the liquid outflow path can be closed until the flow path closing member is removed, which makes it easy to avoid liquid leakage. Furthermore, the flow path closing member is disposed in such a way as to be removable to the outside, and thus, for example, after the liquid replenishment container is mounted in the liquid ejecting apparatus in the upside-down position, the liquid outflow path can be opened at any timing intended by a user, which is convenient for the user.

Further, when reusing the liquid replenishment container, there is no need to remove the flow path closing member from the inside of the liquid replenishment container, which makes reuse easy.

(6) In the liquid replenishment container according to the aspect, the flow path closing member may be clamped by elastic sealing members disposed in the liquid outflow path. According to the aspect, after the flow path closing member is removed, the gap can be sealed by the elastic sealing members, so that liquid leakage is unlikely to occur.

(7) In the liquid replenishment container according to the aspect, the liquid outlet-forming portion may include a positioning portion that is disposed on an outer surface of the liquid outlet-forming portion and comes into contact with the liquid ejecting apparatus in a state in which the valve is opened by the liquid introduction needle, and the flow path closing member may be positioned more adjacent to the container body portion than the positioning portion in a liquid outflow direction of the liquid outflow path.

According to the aspect, in a state in which the liquid replenishment container is mounted on the liquid ejecting apparatus in the upside-down position and the valve is opened by the liquid introduction needle, the flow path closing member is positioned above the positioning portion. Therefore, the user can easily remove the flow path closing member after mounting the liquid replenishment container on the printer.

Further, the present disclosure is applicable not only to an ink jet type but also to a liquid replenishment container that replenishes a liquid in any liquid ejecting apparatus that ejects a liquid other than ink.

What is claimed is:

1. A liquid replenishment container that replenishes a liquid in a liquid ejecting apparatus including a liquid introduction needle via the liquid introduction needle, the liquid replenishment container comprising:
a container body portion having an opening and configured to contain the liquid; and
a liquid outlet-forming portion coupled to the container body portion and including a cylindrical portion that defines a liquid outflow path communicating with the opening, wherein
the liquid outlet-forming portion includes a sealing member disposed in the liquid outflow path, a valve disposed in the liquid outflow path, and a flow path closing member disposed in the liquid outflow path between the opening and the valve,
the valve includes a spring member, a valve body that comes into contact with the sealing member by being urged by the spring member in a valve-closed state and is separated from the sealing member by being pressed by the liquid introduction needle inserted into the liquid outflow path in a valve-open state, and a contact portion that moves in conjunction with the valve body at least in the valve-open state and comes into contact with the flow path closing member, and
the flow path closing member is an inner plug that is engaged with the liquid outlet-forming portion, the inner plug configured to be disengaged from the liquid outlet-forming portion by being pressed by the liquid introduction needle via the valve when the liquid replenishment container is used for a first time.

2. The liquid replenishment container according to claim 1, wherein
the valve body includes a side wall portion integrally formed with the valve body and extending in an axial direction of the cylindrical portion, and
the contact portion is formed on an end surface of the side wall portion in the axial direction.

3. A liquid replenishment container that replenishes a liquid in a liquid ejecting apparatus including a liquid introduction needle via the liquid introduction needle, the liquid replenishment container comprising:
a container body portion having an opening and configured to contain the liquid; and
a liquid outlet-forming portion including a cylindrical portion that defines a liquid outflow path communicating with the opening, wherein
the liquid outlet-forming portion includes a valve that is disposed in the liquid outflow path, is opened when the liquid introduction needle is inserted into the liquid outflow path, and is closed when the liquid introduction needle exits from the liquid outflow path, and a flow path closing member disposed in the liquid outflow path, and
the flow path closing member is separably fixed to the liquid outlet-forming portion, is positioned downstream of the valve in a liquid outflow direction of the liquid outflow path, and has a groove or recess directed downstream in the liquid outflow direction.

4. The liquid replenishment container according to claim 3, wherein
the flow path closing member is detachably attached to a downstream end portion of the liquid outlet-forming portion in the liquid outflow direction by a separate fixing member.

5. A liquid replenishment container that replenishes a liquid in a liquid ejecting apparatus including a liquid introduction needle via the liquid introduction needle, the liquid replenishment container comprising:
a container body portion having an opening and configured to contain the liquid; and
a liquid outlet-forming portion including a cylindrical portion that defines a liquid outflow path communicating with the opening, wherein
the liquid outlet-forming portion includes a valve disposed in the liquid outflow path and opened by the liquid introduction needle inserted into the liquid outflow path, and a flow path closing member disposed in the liquid outflow path in such a way as to be removable to an outside.

6. The liquid replenishment container according to claim 5, wherein
the flow path closing member is clamped by elastic sealing members disposed in the liquid outflow path.

7. The liquid replenishment container according to claim 5, wherein
the liquid outlet-forming portion includes a positioning portion that is disposed on an outer surface of the liquid outlet-forming portion and comes into contact with the liquid ejecting apparatus in a state in which the valve is opened by the liquid introduction needle, and
the flow path closing member is positioned more adjacent to the container body portion than the positioning portion in a liquid outflow direction of the liquid outflow path.
